(19) United States
(12) Patent Application Publication
(10) Pub. No.: US 2003/0040970 A1
(43) Pub. Date: Feb. 27, 2003

(54) Online classified advertising creation, management and viewing system

(76) Inventor: Kenneth J. Miller, Chappaqua, NY (US)

Correspondence Address: KATTEN MUCHIN ZAVIS ROSENMAN, 575 Madison Avenue, New York, NY, 10022-2585, US

(21) Appl. No.: 09/934,012

(22) Filed: Aug. 21, 2001

(51) Int. Cl. G06F 17/60

(52) U.S. Cl. 705/26

(57) ABSTRACT

A merchant or other person (“merchant”) wishing to place online classified advertisements (“ads”), can create, schedule for insertion and otherwise manage ads via HTTP communications between a browser program and a website (“Merchant Site”). The various features are made available on the browser in the form of pages containing static HTML-tagged structures and content, as well as dynamic content via embedded Javascript and Java applet components. The pages are requested from and sent to the browser by the Merchant Site server over the Internet.

A shopper or other person (“shopper”) wishing to view ads online uses a browser-based series of HTTP communications with a website (“Shopper Site) to request and receive over the Internet currently running classified ads created and placed as described above. The Shopper Site server responds to requests by the shopper to perform various functions that are necessary to or that enhance the online viewing of ads and their use as an aid to shopping offline and/or online.

In addition to the Merchant and Shopper Sites, there is a database server (“DB Server”) that accesses a centralized database that stores information relating to merchants, ads, shoppers, sessions and the persistent states of information and various features available through the Merchant Site and the Shopper Site, respectively. A series of database manager components running on a website server (“DB Home Site”) manages access to the database run by the DB Server.

Communications between the Merchant Site server and the DB Home Site server, and between the Shopper Site server and the DB Home Site server, are managed by resident data transfer components and processes that employ HTTP and FTP transfer protocols over a local area network if the servers are physically connected or over the Internet if they are not physically connected.

### FIELD OF THE INVENTION

The present invention relates generally to advertising in an electronic network and more particularly to an online classified advertising creation, management and viewing system.

### DESCRIPTION OF THE INVENTION

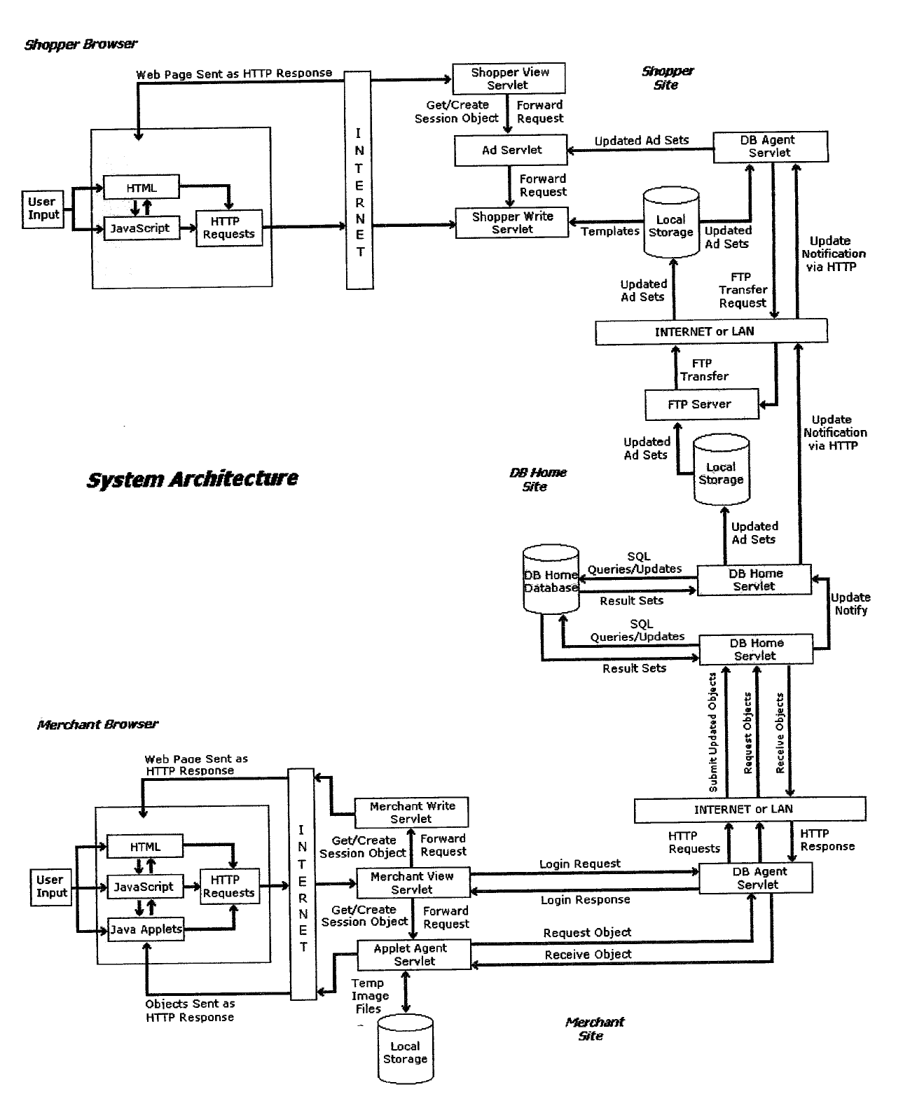

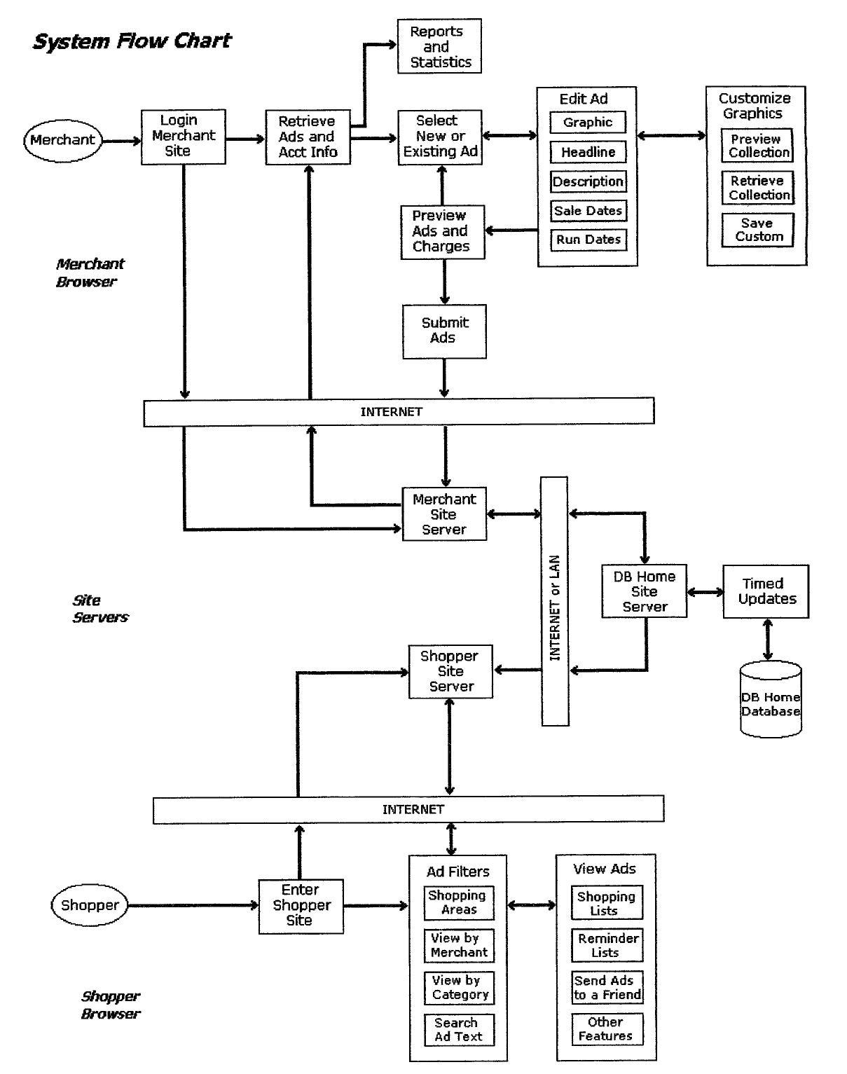

The system described in conjunction with FIGS. 1 and 2 depicting a system flow chart and system architecture comprises a fully integrated set of software components and processes for the creation, management and viewing of online classified advertising. These components and processes, taken together and individually, embody a number of innovations and unique aspects when compared to existing classified advertising methods and related software known to be available online and when compared to non-Internet classified advertising methods.

The Merchant Site enables a non-expert user to create categorized and fully searchable text ads with customized graphic elements, as well as automatically updated time-dependent ad messages, and enables the foregoing to be accomplished wholly within the confines of a standard Internet browser running on an industry standard personal computer with a standard Internet connection. Using the Merchant Site, the merchant can self-manage the entire process of creating, scheduling and monitoring classified ads, thereby eliminating the need for and attendant costs of purchasing, installing, learning and using separate software packages for one or more of these tasks, the need for hiring and involving third parties in order to accomplish these tasks and the deadlines and delays inherent in the process of placing ads in other media without these tools.

Once the ad content is created by the merchant through the browser-based tools available through the Merchant Site, the system includes software components and processes for transferring the ad content and related data over the Internet between the merchant's computer and the Merchant Site server and between the Merchant Site server and the DB Home Site server. The DB Home Site server includes software components that automatically engage in further processing of the submitted ad content, including insertion of updated time-dependent ad phrases, image management for graphic elements and persistent storage. The system further includes software components and processes for the real-time or near real-time automatic propagation of ads to the Shopper Site. Upon connection to the Shopper Site, a shopper is able to view currently running ads with a series of browser-based software tools that enable and enhance the use of classified ads as an aid to online and/or offline shopping. The system is thus unique and innovative in providing components and processes that fully integrate the entire classified advertising process from the electronic creation of ad content by the merchant through the viewing of online classified ads by the shopper.

Certain existing websites offer the ability for a merchant to compose and submit text-only ads. Other sites (not necessarily the same sites) offer a means to upload ad text and/or ad graphics after ads are created offline in a specified format using whatever offline software packages the advertiser has available. These sites then permit the user to transfer the resulting files to the website for further processing by the website before the ad is scheduled and actually appears. However, no presently known website allows all of these tasks to be accomplished entirely through interactions with the tools provided on the website itself. Thus, by means of easily manipulated user interface elements available on the Merchant Site's pages displayed in a standard Internet browser, the merchant can compose, schedule, submit and monitor classified ads. Since nothing more than a personal computer running a standard Internet browser over a standard Internet connection is required, the advertiser avoids the need for multiple installations of separate ad composition and graphics design software on each computer from which the merchant would wish to create, schedule and/or manage his ads. Because the tools are made available over the Internet each time a session is started, the tools can the updated by the site operator to include improvements and additional features without significant user involvement or expense. In addition, rather than requiring significant additional processing of files to verify they are in correct format and subsequent processing prior to the actual display of ads on existing websites, the use of the integrated suite of tools of the system assures the preparation and submission of ads in correct format and enables the ads to be inserted automatically by the system and displayed correctly during their scheduled run dates.

Once an ad has been created and electronically submitted by the merchant, no human intervention is necessary to accomplish the insertion, updating with time-dependent ad phrases, and the transfer of running ads to the Shopper Site where they are made available for viewing online. In the case of an ad that is scheduled to start running immediately, the system enables the ad to be created, submitted and commence running in real time or near-real time, subject only to system latency, Internet transit times and scheduled automatic update processes. This real-time or near real-time capability allows the advertiser unique flexibility in creating timely classified ads, responding to competitors' marketing efforts and meeting the advertiser's short term advertising needs (such as sales promotions, eliminating overstock situations, traffic generation, introductory offers, loss leaders, etc.), all of which can be accomplished without the closing deadlines, human processing time and delays inherent in existing methods and systems used for the preparation and dissemination of classified advertising.

In addition to the innovations represented by the system described in this document considered as a whole, several components of the system also represent independent innovations. These are (i) the ad composition tools used for the online creation of classified ads including customized graphics, (ii) the automatic generation, updating, insertion and display of time-dependent advertising phrases and (iii) the date range selection tool of the ad composition applet available through the Merchant Site (described more fully below).

The Ad Composition Applet is comprised of a set of browser-based tools that enable the non-expert user to create, modify and submit categorized text ads with graphical elements customized as to color, font and/or text content and to save those customized graphics in user-created collections available for future use and further customization. The ability to perform all of these tasks utilizing only a standard Internet browser and HTTP transfers between the user's computer and the Merchant Site over a standard Internet connection further distinguishes this component from other known software.

The DBHome Site server contains a component that automatically generates and includes in the body of an ad, short advertising messages based on time-dependent factors relevant to the ad in question, such as the number of days remaining to the start of a sale offer, the number of days remaining in a sale offer, that an offer is limited to one day only, etc. These messages are automatically generated, updated over time, and inserted by this component according to rules specified in software, without any user intervention beyond the advertiser's specification of the sale and run date ranges when the ad is initially created and submitted through the Ad Composition Applet available through the Merchant Site. No other known website or non-Internet advertising medium has this capability (see discussion pages 6 through 12 herein).

The date range selection tool included in the Ad Composition Applet itself constitutes a significantly innovative device for the selection and display of the chronological sequences necessary to specify date ranges. In the Merchant Site, these date ranges consist of the starting and ending dates that will appear if an ad has an explicit time-delimited sale offer, and, in the case of all ads, the dates the ad will commence and end its run on the Shopper Site. The date range selection tool is not, however, limited in its applicability to classified advertising or the Merchant Site and would be useful in any online or non-Internet software program that involves the user's selection and viewing of a graphical and textual representation or one or two, possibly overlapping, date ranges (see additional description of the date range selection control appearing in this document at page 7).

The components and processes comprising the system described herein are intended to be realized as computer software. Since the system is intended to enable ad creation, management and viewing of classified advertising over the Internet, the preferred embodiment of the system would be a series of software components and processes adhering to certain widely used industry standards for data interchange and interaction with industry standard Internet browsers and servers. The following represents a listing of the material industry standards to which the software components of the system would preferably adhere:

Internet (WorldWideWeb) browser software compliant with HTTP 1.0 protocol, HTML 3.0 (or higher) specification and compliant with Java 1.1 and Javascript 1.0 specifications.

Internet (WorldWideWeb) server software compliant with Java Servlet 2.1 API, HTTP 1.0 protocol and FTP protocol.

The software components and processes are intended to be implemented in a platform-independent fashion, i.e., they may be embodied in software designed to run on any computer hardware system whose operating system and related components support software adhering to the above standards and specifications for browsers and servers, respectively.

Description of DB Home Site

DB Home Site is a website server application configured for HTTP protocol transfers. There is also an FTP enabled server application for bulk transfers of data files between servers (“FTP Server”). DB Server runs a relational database application. The relational database contains information concerning merchants, their store locations and contact and billing data, ads and their constituent fields, including graphic elements, headline and goods/services category, ad text, sale dates (if applicable), ad run dates, special ad messages, etc. The database also contains information concerning registered and unregistered users of the Shopper Site and their sessions.

A database manager component (“DB Manager”) running on the DB Home Site server handles all requests for-information from DB Server, handles requests to update the database, and initiates notifications sent by another component running on the DB Home Site server to the respective Merchant and Shopper Site servers that updated data is available.

A database update component (“Message Manager”) running on the DB Home Site server automatically triggers daily or other periodic updates of the text of certain ad messages. These messages are then inserted in the body of ads by the ad composition methods of DB Manager. These messages consist of time-dependent advertising phrases such as “Last 2 days” or “Sale ends tomorrow” or other appropriate phrases that apply to certain ads and are inserted by the DB Manager component, where appropriate, based on such criteria as the current date and the original and remaining duration of a sale or other time-delimited or time-sensitive offer.

When an updated ad set or other updated data used by the Shopper Site or Merchant Site server is available, an exchange of notifications and requests (a “conversation”) takes place via HTTP GET or POST requests between a component of the DB Home Site server and a component of the Shopper Site or Merchant Site server, as applicable (“DB Agent”). The parameter string or data stream included in each HTTP GET or POST request specifies the nature of the communication and sends an encrypted data string (“baton”) that authenticates the sender and, in the case of batons sent by DB Agent, also evidences that DB Home has previously granted permission for DB Agent to proceed with the next step in the conversation. Batons exchanged between DB Agent and DB Home are encrypted by the sender (i.e., either DB Home or DB Agent) in such manner that only the intended recipient (i.e., the other of DB Home or DB Agent that is not the sender) will be able to decrypt it using mutually available information and encryption methods. After decryption, the recipient reconfigures and re-encrypts the baton so as to authenticate itself to the other in its response. Each baton is only valid for one exchange in a conversation consisting of several exchanges.

In addition to the conversations commenced by notification from DB Home that updated data is available, the Shopping Site or Merchant Site server may also initiate the transfer of ad sets, image collections, account data sets and other data needed for initialization upon startup, as well as data to be submitted to DB Home for further processing and/or persistent storage. These transfers also begin by commencing a conversation via a request sent by DB Agent to DB Home accompanied by the starting baton, which is derived from information and using methods mutually known by and available to DB Agent and DB Home. The conversation then proceeds generally as described above. Data are transferred via non-anonymous read-only FTP transfers or by Java object output streams sent in response to HTTP requests.

The URLs for the HTTP requests comprising a conversation are resolved by the DB Home Site server and the Shopper Site server or Merchant Site server, as applicable, to calls to service handling methods within Java servlets running on the respective servers.

Description of Merchant Site

A Merchant who wishes to use the Merchant Site is identified and pre-registered by an offline process that includes the establishment of an online account for the merchant as a registered user of the Merchant Site. In the case of first time use by a newly registered merchant, the user is prompted to choose a username and password in his initial attempt to navigate the Merchant Site beyond its home URL. An accepted username and password are then sent via email over the Internet to an address that was previously established via the offline component of the initial registration process and retrieved from the merchant account information stored in the database run by DB Server. After logon, the merchant may navigate the Merchant Site to access its features beyond the home URL.

Ad Creation and Submission

The Merchant Site server provides the merchant with a series of tools that enable the Merchant to create and insert, in real or near-real time, customized classified ads that will run on the pages served by the Shopping Site server (see below). These tools are contained in HTML-tagged pages sent to the merchant's browser in response to HTTP POST or GET requests, and take the form of a combination of static HTML-tagged structures and content, such as images, tables and forms, dynamic content coded in Javascript embedded in HTML pages, and one or more Java applets or similar mobile code components embedded in HTML pages.

The process of creating an ad starts with an empty grid displayed as an HTML table in a portion of the ad creation page sent by the Merchant Site server upon receiving an HTTP request from the merchant's browser to start a new ad. The user selects a field by mouse click which causes the browser to invoke a Javascript event handler embedded in the page that, in turn, invokes a function within a Java applet (“Ad Composition Applet”) started by the browser based on an <APPLET> tag embedded in the page. A dialog box is then presented by the Ad Composition Applet for the appropriate type of content to be inserted in the field. Fields include the following:

A graphic element that will appear as part of the ad. The user can choose from a series of stock graphics available in a visual palette or menu. The user can customize certain portions of a stock graphic element, such as its background color, the font used to display text as part of the graphic, the text color and the text itself A customized graphic can be added to a customized graphic collection maintained for the user's subsequent use and/or further modification. The user can download additional collections of stock graphics from which individual graphics may be chosen, customized and/or saved for future use.

Headline text that identifies in a few words the goods or services being offered in the ad. The user is presented with an input control that allows the entry and editing of text as well as an input control that allows the user to select from a list the appropriate category to which the offered goods or services belong.

Descriptive text that describes the product or service offered and the terms of the sale or other offer. The user is presented with an input control that allows the entry and editing of text.

Date text, if applicable, that identifies the dates upon which a sale offer commences and ends, as well as the dates upon which the ad run commences and ends. The user is presented with a dialog box containing a graphical representation of a calendar grid that the user sets to the desired month and year by mouse operations on an input list control. The user selects a start date and an end date for the sale offer by mouse click on the cells in the calendar grid representing these dates. This action is depicted by a color coded fill in the cell for the start date and a different color coded fill for the end date, or a split colored fill for a cell representing a date that is both the start and end date. If the start date and end date are not the same, the intervening dates are color filled to signify the sale run dates. A similar process is used to designate the start and end dates of the ad run. The dates spanning the ad run are identified by a different color coding than the sale run color coding. The color coding for the sale run occupies the upper horizontal portion of the cell representing each date in the run, while the color coding for the ad run occupies the lower portion of the cell representing each date in the ad run. Adjacent dates within a given row of the calendar grid thus appear to be connected by a horizontal line signifying to which run or runs such dates belong. At the same time that each start and end date is selected and visually depicted in the calendar in the above manner, a text representation of each such date appears in another portion of the dialog box. Once the user has set the start and end dates for the sale run and ad run, the user can preview the special ad messages that the system will insert in the ad for each day of the ad run. These messages take the form of short marketing phrases, such as “Two days only!” or “Sale ends tomorrow!” or other messages that are time-oriented or time-sensitive. The content of these messages is dynamically varied over time by the system without user intervention. This is accomplished by the Message Manager component of the DB Home Site server in conjunction with the DB Manager as part of a daily automated update process that culminates in the transfer of updated ad sets to the Shopping Site server (see above for a description of the update and transfer processes).

After the user has completed the entry of content for a given field in the ad being created, the user clicks a dialog button to accept the entry or cancel the entry and dismiss the dialog for that field, or, alternatively, dismissal of the dialog occurs when a new field is selected in the ad-in-progress grid area on the page. Upon acceptance of an entry, the field of the ad-in-progress is populated with a representation of the content just added or modified. This is effected via a Javascript function, called from the Ad Composition Applet, that dynamically inserts HTML-tagged text content that the browser will display in the table cell comprising the applicable field in the ad-in-progress grid. In the case of the graphic element for the ad (if any), the image data is transferred from the Ad Composition Applet to a separate display applet embedded in one of the HTML table cells of the ad-in-progress grid. The use of this separate display applet allows the image to be rendered on the page outside the display rectangle of the Ad Composition Applet.

When the ad is completed or is to be retained in a partially completed (draft) state, the user clicks a button appearing on the page that invokes a Javascript handler which dynamically inserts the HTML tags comprising the ad-in-progress into a separate page (frame) displaying pending additions to be sent to the Merchant Site. At the same time, the graphic element for the ad (if any) is transferred to another separate display applet located on this page (frame). This separate applet is embedded in a cell of an HTML table contained in this page (frame), and this applet renders the graphic element so that it is displayed adjacent to the table cells containing the text portion of the ad to which it relates. Internal data structures representing the content of each field are stored within the Ad Composition Applet and separate display applet for each such pending addition.

When a user starts a session, the Ad Composition Applet retrieves from the Merchant Site server various data objects needed for the tools and user data available in the Ad Composition Applet. These include standard data such as stock graphics and category lists, as well as user-specific information collected upon inception of a user's account and user-specific data captured during prior sessions, such as pending ads and their current status, customized graphics previously created and saved by the user, and billing and account data collected from prior sessions. The Ad Composition Applet uses certain of this data to initialize the pending ads display applet and the adjacent HTML representing the textual content of the ads that also appears in the pending ads display page (frame).

Additional features of the Ad Composition Applet include transmitting requests to the Merchant Site server for a printable preview page showing the ads being worked on and those previously submitted to the Merchant Site, transmission of requests for a pre-submission worksheet showing new and modified ads ready for submission and their billing charges, as well as previously completed and submitted ads for which deletion is being requested, and transmission of requests for actual submission of such ads once the pre-submission worksheet has been received and approved by the user.

Pending additions, modifications and deletion requests are sent from the Merchant Site server to the DB Home Site server (see below) and are stored in the database managed by DBServer, along with other session-specific data. After an ad has been submitted, the user can, in the same or a subsequent session, select an ad by clicking on it in the pending ads area and, through a combination of Javascript handlers for this event and functions called in the Ad Composition Applet and the applet embedded in the pending ads HTML table structure, the selected ad is made the current ad-in-progress. Once this occurs, the ad may be modified in the same manner that a new ad can be modified during the process of its creation, or it may be deleted (if not yet submitted) or marked for a deletion request (withdrawal) if already submitted.

As modifications are made or ads are marked for deletion (withdrawal), data structures are created and/or modified in the Ad Composition Applet reflecting the modified ad fields and identifying ads to be withdrawn. These data structures are in addition to data structures maintained by the applet to contain the fields for pending additions and the HTML tags used for rendering the ad-in-progress and other pending ads. The user clicks on a button displayed on the page (frame) containing the Ad Composition Applet to indicate the user's request to submit pending additions, as well as modified versions of previously submitted ads (including permitted corrections of running ads), and any permitted requests to withdraw ads. A Javascript handler notifies the pending ads display applet of this event and this applet responds by encoding and sending the Merchant Site server an image file representing the graphic elements currently being rendered by the pending ads display applet. In addition, the handler calls an Ad Composition Applet method that sends the pending ad set and related transaction data to the Merchant Site server.

Once this information has been sent, the Ad Composition Applet calls a Javascript function in the pending ads display page, which, in turn, triggers the sending of an HTTP request to the Merchant Site server to open a new window (page) containing the pre-submission worksheet. A servlet running on the Merchant Site server dynamically composes and inserts into the response output stream the HTML-tagged content for text portions of the pre-submission worksheet page and including an <1MG> tag specifying the file containing the composite image of the graphic elements and separators for the graphic elements of pending ads. The browser's loading of the pre-submission worksheet page is detected by a Javascript function in the pending ads display page, which then causes the HTML tags representing the ads table in the pending ads display page to be copied into corresponding tags in the pre-submission worksheet page. This is effected via use of Javascript operations on document object model references to elements represented by these HTML tags.

The pre-submission worksheet page includes HTML table structures displaying the new and modified ads to be submitted as well as those to be withdrawn, includes the graphic elements for each ad, the headline and other text content of each ad, information about its run dates and category, as well as a display of the cost of the additions, modifications and withdrawals (“Ad Updates”) in currency, ad unit allowances, or other measures of ad cost or service charges based on the merchant's billing arrangement. The billing data is made available to the applet as persistent data retrieved by the DB Manager component of the DB Home Site server from the merchant information stored in the database it manages, and is sent to the Ad Composition Applet upon initialization when the user starts an ad composition/modification session.

After receiving the pre-submission worksheet page, the user may confirm or cancel the submission. If the user has confirmed the submission, by mouse click on a button appearing on the page, this event is handled by a Javascript handler that calls a method of the Ad Composition Applet. The applet responds by sending an HTTP request to the Merchant Site server signifying that the data objects comprising the Ad Updates be submitted for update processing. Upon receiving such update request, the DB Agent component of the Merchant Site server commences an update conversation with DB Home Site server.

The baton mechanisms for the update conversation with DB Home Site server are substantially similar to those described above. In this case, the Ad Update data is transferred by the Merchant Site server to the DB Home Site server via HTTP POST request as POST data (object output streams), rather than via FTP. The DB Home Site server receives the HTTP update request and forwards this to an update servlet (UpdateManager) running on the DB Home Site server. Update Manager creates and adds to a local store the pending update requests received from Merchant Site server and accumulates them over a preset period of time for all merchants who have invoked the update process since the last update. When the accumulation period has elapsed, Update Manager requests the DB Manager component of the DB Home Site server to create and execute the SQL statements needed to effect the updates. The DB Manager opens a connection to DB Server and executes the update procedure. As part of the update process, customized images for graphic elements are generated using customizing data contained in the data objects accompanying the update request. These images are then encoded and saved in a file format suitable for display by a standard Internet browser. The ad set assembly servlet of DBHome inserts the image file names in <1MG> tags that are included in the HTML tagged content for each ad that includes a graphic element.

At the end of a preset time period elapsed since the last such update was executed, DB Manager commences an ad set update procedure that involves the notifications and communications with the Shopping Site server described above. Subject to the preset accumulation periods imposed by UpdateManager, the update execution period imposed by DB Manager, transmission and receipt delays for HTTP conversations and FTP transfers, and system latency in processing the requests involved, the modified ad sets containing and giving effect to new or (if permitted) corrected or withdrawn ads will become available in real time or near-real time for display in response to requests received by the Shopping Site server.

Ad Management Tools

In addition to the ad creation, modification and insertion features available through the Ad Composition Applet and the related components described above, a merchant may, by clicking a button or other user input component displayed in the browser, cause an HTTP request to be sent to the Merchant Site server requesting the ad management applet. The Merchant Site server's account manager component retrieves data pertaining to the merchant's account from account data sets and updates thereof periodically received from the DB Home Site server. The mechanisms for the notification, initiation and transfer of merchant account data sets for these functions is substantially similar to the mechanisms utilized for the notification, initiation and transfer of ad sets between the DB Home Site server and the Ad Composition Applet.

The features available in the ad management applet include the display of ad costs incurred for the current and requested historical periods, as well as statistics concerning the number of ads run, their durations, number of ads displayed, number of ads clicked on and other statistics concerning ad usage.

Request Handling Servlets

The components of the Merchant Site server include Java servlets that are responsible for the site's various functions. The receipt of user requests and retrieval/initialization of session objects is handled by one such component that acts as a common entry point for all requests (“Merchant View Servlet”). Merchant View Servlet passes the request and the new or retrieved session object to a separate component or servlet that is responsible for processing the request.

In the case of communications requiring an exchange of data objects between the Merchant Site server and individual instances of the Ad Composition Applet and related applets running on users' browsers, these requests are forwarded to and handled by a separate servlet (“Applet Agent”). Applet Agent determines the nature of the request and either communicates a request for data to the DB Agent servlet running on the Merchant Site server or, if the user is submitting data, retrieves the data objects from the HTTP request and forwards them to DB Agent. DB Agent then either sends the request for data to DBHome Site or sends the submitted data objects to DBHome Site. Data objects that have been requested by an instance of the Ad Composition Applet and related applets are received by DB Agent in response to the request, then forwarded to Applet Agent where the response is assembled and output to the requesting applet.

In the case of communications requiring the display of information in an HTML page, the Merchant View Servlet component of the Merchant Site forwards the request to Merchant Write Servlet, another component of the Merchant Site server. This servlet is responsible for assembling the HTML-tagged structure and content of all pages served by the Merchant Site server. Merchant Write Servlet assembles the pages by populating fields in HTML templates that are stored as files locally maintained by the Merchant Site server. The fields are populated with session-specific content, including certain user-specific data retrieved via Applet Agent as described above and retained as session-specific data. Merchant Write Servlet uses browser cookies, hidden input fields or URL rewriting techniques (response encoded URLs) to provide a mechanism for subsequent HTTP requests to be identified by Merchant View Servlet to the session object for a particular user. After Merchant Write Servlet completes the page generation, the page is sent to the browser as a response to the original request received by Merchant View Servlet.

Communications with DB Home Site

The principal communications between the Merchant Site server and the DB Home Site server have been outlined above and include:

Merchant logon and requests to establish or change username and/or password;

Merchant requests to start and end an Ad Composition Applet session;

notifications and transfers of new ads and modified ads created by the merchant, as well as requests to delete (withdraw) ads previously submitted;

requests for persistent data from the merchant's last Ad Composition Applet session;

requests for ad creation components (such as stock graphics and previously customized image collections);

requests to start and end an ad management applet session;

merchant account data sets used by ad management applet to display reports of ad status and statistics relating to the display of ads placed on the Shopper Site, costs of ads, etc.

Description of Shopper Site

The Shopping Site server handles HTTP GET and POST requests sent by the user's web browser over the Internet. The content available on the pages served by Shopping Site server in response to these requests includes the ads created and submitted by merchants through the Merchant Site server, as outlined above. The pages consist of HTML-tagged content and structures, as well as Javascript event handlers and methods for dynamic insertion of content into or modification of the current page.

Available Functions and Features

The primary functions and features available through pages served by the Shopping Site server enable the shopper:

to select which ads are displayed and how the ads are grouped for display, including groupings by location, by merchant, by categories of goods and services;

to search for ads by text content;

to include ads of interest in a shopping list page that can be dynamically modified by the shopper locally without communication with the server and that can be requested in the form of a printable page;

to select and send via email to other persons of the shopper's choosing, a printable copy of selected ads, along with an accompanying text message created by the shopper, as well as content inserted by the Shopper Site server;

to request printable maps showing locations of land-based merchants; and

to request reminder notifications from the Shopper Site concerning the status of ads chosen by the shopper, such as the commencement or near ending of sale offers of interest.

Request Handling Servlets

The components of the Shopping Site server include Java servlets that are responsible for the site's various functions. The receipt of user requests and retrieval/initialization of session objects is handled by one such component that acts as a common entry point for all requests (“Shopper View Servlet”). Shopper View Servlet passes the request and the new or retrieved session object to a component (“Adset Servlet”) that is responsible for identifying the nature of the request and processing the request.

In the case of requests for the display of ads, Adset Servlet retrieves from its local cache the current ad set (previously distributed by the DB Home Site server) that contains the requested ads. If the ads in a standard ad set are to be filtered by user criteria, such as specific merchants or specific categories of goods, Adset Servlet creates the filtered ad set. Adset Servlet is also responsible for storing in a session object, references to the requested ad set, filter criteria and related session-specific data for persistence between HTTP requests. If the request is for an expanded ad set (e.g. combining multiple geographical regions), Adset Servlet creates the ad set by combining its locally cached standard ad sets. As updated ad sets are received by the DB Agent component of Shopper Site server, Adset Servlet updates its local cache. Updating of filtered ad sets is deferred until a request is received from the user whose session object contains a reference to the filtered ad set. Once such a request is received, the filtered ad set is regenerated by Adset Servlet by applying the filter criteria stored in the session object to the then-current (i.e., updated) relevant standard ad sets in the local cache.

In the case of requests that do not involve the display of ad sets, such as requests that will display pages other than ads, Adset Servlet is responsible for retrieving and parsing the request parameters and setting the data structures in the session object accordingly.

Once Adset Servlet has finished processing the request, it forwards the request to Shopper Write Servlet, another component of the Shopping Site server. This servlet is responsible for assembling the HTML-tagged structure and content of all pages served by the Shopping Site server. Shopper Write Servlet assembles the pages by populating fields in HTML templates that are stored as files locally maintained by the Shopping Site server. The fields are populated with session-specific content, including, in the case of a page displaying ad sets, the HTML-tagged content and structures retrieved and/or prepared by Adset Servlet, a reference to which was (among other data) stored in the session object for the requesting user. Shopper Write Servlet also uses browser cookies, hidden input fields or URL rewriting techniques (response encoded URLs) to provide a mechanism for subsequent HTTP requests to be identified by Shopper View Servlet to the session object for a particular user. After Shopper Write Servlet completes the page generation, the page is sent to the browser as a response to the original request received by Shopper View Servlet at the outset of the process described in this section.

Communications with DB Home Site

Communications between the Shopper Site server and the DB Home Site server take place in the manner described above and include:

shopper logon for (optionally) registered users who enjoy special privileges/features and retrieval of persistent data for the last session for each registered user;

requests for sets of ads for display grouped by location and by content categories that may be chosen and/or changed by the shopper;

requests for sets of user-selected sets of ads in various feature-specific display formats, such as shopping lists, lists of ads to be sent via email to others specified by the shopper, or lists of ads for which email reminders are requested by the user;

the preparation and distribution to the Shopper Site server of updated ad sets and other related data;

requests for maps or other feature-specific information requested by the shopper.

While the preferred embodiment of the invention has been depicted in detail, modifications and adaptations may be made hereto without departing from the spirit and scope of the invention as delineated in the following claims.

What is claimed is:

1. A process for the management on messages in an electronic network, said process comprising the steps of:
authorized users to creating a message in said network at particular locations using features available to users of said network at a point in the network reachable by said user;
message seekers viewing according to message selection criterion the messages created by the authorized users;
providing a centralized database to store and distribute information relating to the authorized users, message seekers and messages; and
managing communications between the authorized users and the centralized database and between the message seekers and the centralized database by resident data transfer over the electronic network.
